(19) United States
(12) Patent Application Publication
(10) Pub. No.: US 2007/0011239 A1
(43) Pub. Date: Jan. 11, 2007

(54) Remote conference system, presence server apparatus, and remote conference participation terminal apparatus

(76) Inventor: Susumu Fujioka, Kanagawa (JP)

Correspondence Address: COOPER & DUNHAM, LLP, 1185 AVENUE OF THE AMERICAS, NEW YORK, NY, 10036, US

(21) Appl. No.: 11/450,194

(22) Filed: Jun. 9, 2006

(30) Foreign Application Priority Data
Jun. 10, 2005 (JP) 2005-170735

(51) Int. Cl. G06F 15/16

(52) U.S. Cl. 709/204

(57) ABSTRACT

A remote conference system is disclosed. The remote conference system includes: at least one remote conference participation terminal apparatus; a presence server apparatus configured to store conference related information and registration information of the remote conference participation terminal apparatus, and a multipoint conference control apparatus configured to control a remote conference, wherein the presence server apparatus determines whether a conference participation permitted terminal included in the conference related information is registered as the remote conference participation terminal apparatus, and the presence server apparatus sends, to the remote conference participation terminal apparatus, connection information used for connecting to the multipoint conference control apparatus when the conference participation permitted terminal included in the conference related information is registered, so that the remote conference participation terminal apparatus connects to the multipoint conference control apparatus to participate in the remote conference according to the connection information.

### BACKGROUND OF THE INVENTION

1. Field of the Invention

The present invention relates to a remote conference system, a presence server apparatus, and a remote conference participation terminal apparatus in which the conference participation terminal apparatus can participate in a conference even when the conference participation terminal apparatus does not have information for participating in the conference.

2. Description of the Related Art

In a conventional remote conference system, a conference participation terminal apparatus has conference participation information such as an address of a multipoint conference control apparatus and a conference ID, etc., so that the conference participation terminal apparatus connects to the multipoint conference control apparatus at a conference holding time to carry out a remote conference (refer to patent document 1).

[Patent document 1] Japanese Laid-Open Patent Application No. 2004-507979

However, in the conventional remote conference technology, there is a problem in that the conference participation terminal apparatus cannot participate in the conference if the conference participation terminal apparatus does not have the before-mentioned information for participating in the conference even though the terminal apparatus is permitted to participate in the conference.

Especially, when the conference participation terminal apparatus is a mobile terminal apparatus such as a so-called note-type personal computer apparatus, there is a case in which the terminal cannot obtain the conference participation information since the terminal apparatus is not connected to the network before the conference is held, for example.

In addition, in the technology disclosed in the patent document 1, a service server sends an IP address information of a receiver to a transmitter so as to establish direct connection between the transmitter and the receiver. But, there is a problem in that the connection cannot be seamlessly continued when the receiver moves to a different network (link) while communication is being performed.

### SUMMARY OF THE INVENTION

An object of the present invention is to provide a remote conference system, a presence server apparatus, and a remote conference participation terminal apparatus for enabling the remote conference participation terminal apparatus to participate in the conference even when the remote conference participation terminal apparatus does not have the information for participating in the conference.

Another object is to enable the remote conference participation terminal apparatus to continue conference communication even though the remote conference participation terminal apparatus moves when the remote conference participation terminal apparatus connects to the conference via a wireless communication network.

The object is achieved by a remote conference system including:

at least one remote conference participation terminal apparatus configured to participate in a remote conference;

a presence server apparatus configured to store conference related information and registration information of the remote conference participation terminal apparatus, and

a multipoint conference control apparatus configured to connect to the remote conference participation terminal apparatus so as to control the remote conference,

wherein the presence server apparatus determines whether a conference participation permitted terminal included in the conference related information is registered as the remote conference participation terminal apparatus, and the presence server apparatus sends, to the remote conference participation terminal apparatus, connection information used for connecting to the multipoint conference control apparatus when the conference participation permitted terminal included in the conference related information is registered as the remote conference participation terminal apparatus, and

the remote conference participation terminal apparatus connects to the multipoint conference control apparatus to participate in the remote conference according to the connection information received from the presence server apparatus.

In an embodiment in the remote conference system, the presence server apparatus determines whether the conference participation permitted terminal included in the conference related information is registered as the remote conference participation terminal apparatus only during conference holding time that is included in the conference related information, and the presence server apparatus sends, to the remote conference participation terminal apparatus, the connection information used for connecting to the multipoint conference control apparatus when the conference participation permitted terminal included in the conference related information is registered as the remote conference participation terminal apparatus.

Also in another embodiment of the remote conference system, after the conference participation terminal starts to perform the remote conference by connecting to the multipoint conference control apparatus, the conference participation terminal does not access the presence server apparatus until communication for the remote conference is disconnected.

In still another embodiment of the remote conference system, in an mobile IP network environment, when the remote conference participation terminal moves to a link that is different from a link to which the remote conference participation terminal is previously connected, the remote conference participation terminal continues conference communication using a handover function.

Also in still another embodiment of the remote conference system, the remote conference participation terminal is connected to a wireless communication network containing a wireless LAN switch apparatus, and when the IP address of the remote conference participation terminal is changed due to movement of the remote conference participation terminal, the remote conference participation terminal continues conference communication using a handover function without accessing the presence server apparatus until the conference communication is disconnected.

The present invention can be also configures as the presence server apparatus and the remote conference participation terminal apparatus.

According to the present invention, even when the remote conference participation terminal apparatus does not have the information for participating in the conference, the remote conference participation terminal apparatus can connect to the multipoint conference control apparatus to participate in the conference by obtaining information for connecting to the multipoint conference control apparatus from the presence server apparatus.

In addition, when the remote conference participation terminal apparatus connects to the conference via a wireless communication network, even though the remote conference participation terminal apparatus moves, the remote conference participation terminal apparatus can continue conference communication without accessing the presence server apparatus. Therefore, there is an effect that convenience of users participating in a remote conference using a mobile terminal is improved.

### BRIEF DESCRIPTION OF THE DRAWINGS

Other objects, features and advantages of the present invention will become more apparent from the following detailed description when read in conjunction with the accompanying drawings, in which:

FIG. 1 shows an example of a network system according to an embodiment of the present invention;

FIG. 2 is a flowchart showing an example of an operation flow of the mobile communication terminal apparatus MTa;

FIG. 3 is a flowchart showing an example of an operation flow of the presence server apparatus SPa;

FIG. 4 is a block diagram showing a network system of another embodiment of the present invention (first situation);

FIG. 5 is a block diagram showing a network system of another embodiment of the present invention (second situation);

FIG. 6A is a schematic diagram showing an IP packet before encapsulation;

FIG. 6B is a schematic diagram showing an IP packet after encapsulation;

FIG. 7 is a flowchart showing an example of an operation flow when the mobile communication terminal apparatus MTa moves from the connection area of the network NTa to an area for connecting to the wireless LAN access point AAb of the network NTb;

FIG. 8 is a block diagram showing a network system of still another embodiment of the present invention (first situation);

FIG. 9 is a block diagram showing a network system of still another embodiment of the present invention (second situation);

FIG. 10 is a flowchart showing an example of an operation flow when the mobile communication terminal apparatus MTa moves from the connection area of the network NTa to an area for connecting to the wireless LAN access point AAb of the network NTb;

FIG. 11 is a block diagram showing a network system of still another embodiment of the present invention (first situation);

FIG. 12 is a block diagram showing a network system of still another embodiment of the present invention (second situation);

FIG. 13 is a flowchart showing an example of an operation flow when the mobile communication terminal apparatus MTa moves from the connection area of the network MNa to an area for connecting to the wireless LAN access point AAb of the network MNb.

### DETAILED DESCRIPTION OF THE PREFERRED EMBODIMENTS

In the following, embodiments of the present invention are described in detail with reference to the attached figures.

The technology of the present invention relates to remote conference communications by a plurality of terminal apparatuses. There are recommendations and standards related to the technology such as “ITU-T recommendation T.120 series (International standard for performing multipoint conference)”, “RFC3261 SIP: Session Initiation Protocol”, “RFC2778 A Model for Presence and Instant Messaging”, “RFC2002 IP Mobility Support”, “RFC2003 IP Encapsulation within IP”, and “draft-ietf-mobileip-ipv6-24.txt Mobility Support in IPv6”. In the following descriptions, since terms and concepts conforming to these technical recommendations and standards are used, please refer to the above-mentioned documents for detailed information for the terms and concepts.

In addition, send and receive of instant messages using the presence service of SIP are realized by a following method. When a device in the presence side connects to the network, the device information is stored in the presence server. The SUBSCRIBE message sent from a watcher side terminal is sent to the device via the presence server, and the device can directly send the NOTIFY message to the watcher side terminal (Henry Sinnreich, Alan B. Johnston “Mastering TCP/IP SIP”; pp. 221-222, Ohmsha, 25 Oct. 2002).

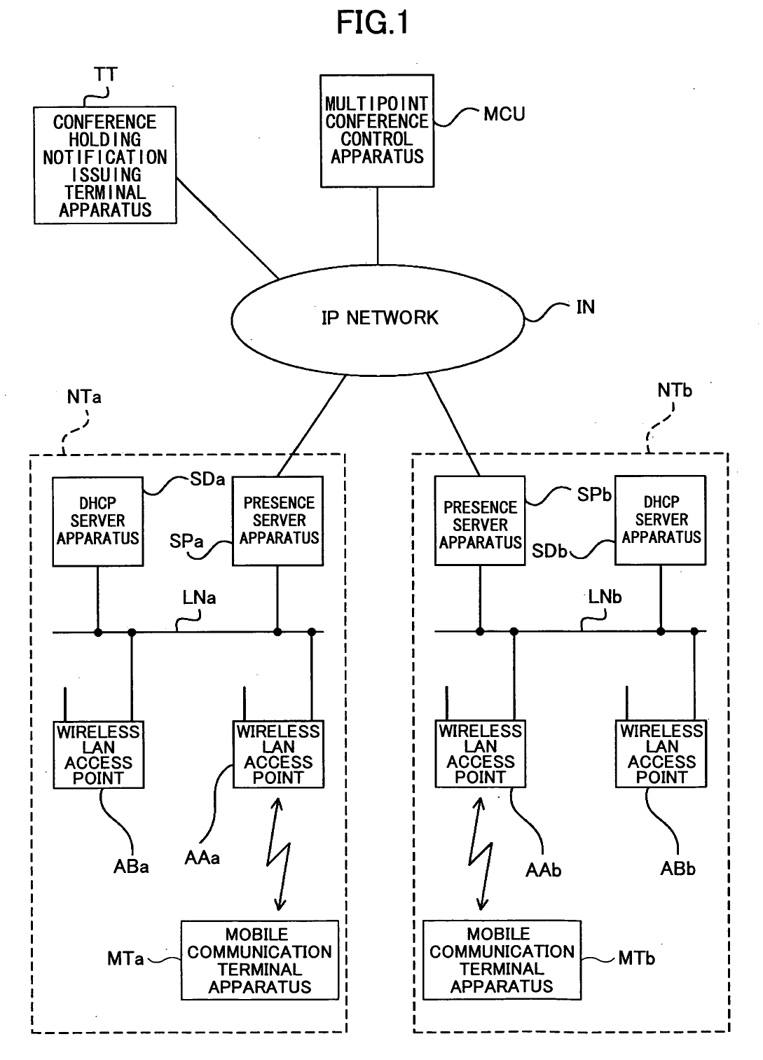

FIG. 1 shows an example of a network system according to an embodiment of the present invention.

In the figure, the multipoint conference control apparatus MCU is for performing conference control conforming to the ITU-T recommendation T.120 series and for mixing voice data and synthesizing (screen dividing/synthesizing) video data and the like. The conference holding notification issuing terminal apparatus TT is composed of a data processing apparatus such as a personal computer apparatus, and distributes conference holding information to an after-mentioned conference participation terminal apparatus and an after-mentioned presence server apparatus.

In the network NTa, there exist a presence server apparatus SPa, a DHCP (Dynamic Host Configuration Protocol) server apparatus SDa, a wireless LAN access point AAa, a wireless LAN access point ABa, and a mobile communication terminal apparatus MTa that is a conference participation terminal apparatus. The mobile communication terminal apparatus MTa is a mobile terminal apparatus such as a note-type personal computer apparatus, for example.

The presence server apparatus SPa includes a SIP proxy function for performing call control, a SIP registrar function for performing registration of the terminal information, a presence agent function for managing presence information of the terminal. In addition, the presence server apparatus SPa stores and manages conference holding information received from the conference holding notification issuing terminal apparatus TT.

In addition, the presence server SPa manages the wireless LAN access points AAa and ABa connected to the same network. When the DHCP server apparatus SDa receives a request for assigning an IP address from a terminal, the DHCP server apparatus SDa assigns an IP address of managed IP addresses to the terminal. Each of the wireless LAN access points AAa and ABa includes a function for bridging between an IEEE802.3 cable LAN and an IEEE802.11b wireless LAN.

The mobile communication terminal apparatus MTa includes a communication function for the IEEE802.11b (wireless LAN), and functions as a conference participation terminal.

On the other hand, in the network NTb, there exist a presence server apparatus SPb, a DHCP server apparatus SDb, a wireless LAN access points AAb and ABb, and a mobile communication terminal apparatus MTb that is a conference participation terminal apparatus. Functions of each apparatus are the same as those in the network NTa, detailed description is not given.

In the above-mentioned configuration, when a conference participant having the mobile communication terminal apparatus MTa enters an area in which communications with the wireless LAN access point AAa are available, the mobile communication terminal apparatus MTa sends a request for assigning an IP address to the DHCP server apparatus SDa, so as to obtain the IP address.

Then, the mobile communication terminal apparatus MTa sends terminal information including the IP address and a unique terminal ID (MAC (Media Access Control) address, for example) and the like to the presence server apparatus SPa by including the terminal information into a REGISTER method of SIP. Then, the SIP registrar in the presence server apparatus SPa registers the terminal information.

By the way, IP addresses of the presence server apparatus SPa and the presence server apparatus SPb existing in another network are registered in the mobile communication terminal apparatus MTa beforehand, so that the mobile communication terminal apparatus MTa selects the presence server apparatus SPa of a network the same as that represented by the IP address obtained from the DHCP server apparatus SDa, so as to send the terminal information.

On the other hand, the conference organizer distributes, from the conference holding notification issuing terminal TT, a conference holding notification to conference participation terminals and presence servers having fixed IP addresses, wherein the conference holding notification includes conference holding date and time (including conference start time and conference end time), the IP address of the multipoint conference control apparatus MCU, a terminal ID list of terminals participating in the conference, a conference ID for identifying the conference, and the like.

When the presence server apparatus SPa receives the conference holding notification, the presence server apparatus SPa stores the conference holding date and time, the IP address of the multipoint conference control apparatus MCU, the conference participation terminal ID list and the conference ID included in the notification.

Then, at the conference holding date and time, the presence server apparatus SPa compares registered terminal IDs with the conference participation ID list to check whether there is a match.

When the terminal ID of the mobile communication terminal apparatus MTa matches with one in the ID list, the presence server apparatus SPa sends an IP address of the multipoint conference control apparatus MCU and the conference ID to the mobile communication terminal apparatus MTa using the instant message of SIP.

When the mobile communication terminal apparatus MTa receives the data, the mobile communication terminal apparatus MTa connects to the multipoint conference control apparatus MCU so as to establish each channel for voice, video, and data (document data, hand-written data, etc.) by SIP. Then, the mobile communication terminal apparatus MTa sends and receives the above-mentioned media data to/from other conference participation terminals via the multipoint conference control apparatus MCU to perform remote conference communications. In addition, in each data channel, conference control and application sharing and the like are performed conforming to the ITU-T recommendation T.120 series.

By the way, when any of the terminal IDs registered in the presence server apparatus SPa does not exist in the conference participation terminal ID list, the presence server apparatus SPa periodically compares the registered terminal IDs with the conference participation terminal ID list during the time when the conference is held so as to check whether there is a match.

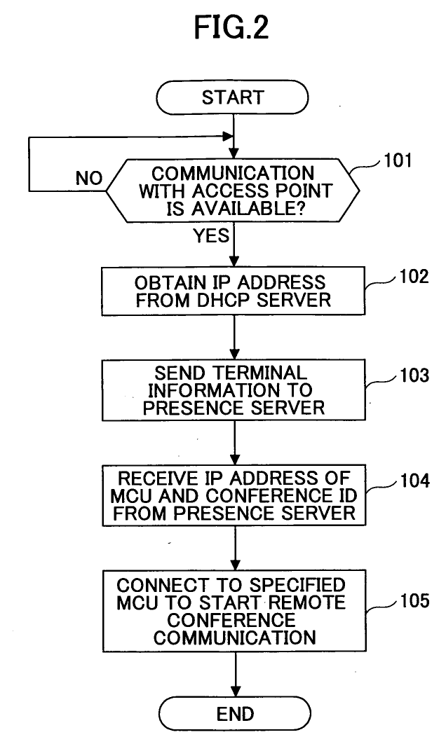

FIG. 2 shows an example of an operation flow of the mobile communication terminal apparatus MTa.

When it is checked that the mobile communication terminal apparatus MTa can communicate with the access point (Yes in determination 101), the mobile communication terminal apparatus MTa obtains the IP address from the DHCP server (process 102). Next, the mobile communication terminal apparatus MTa sends the terminal information to the presence server (process 103).

Next, the mobile communication terminal apparatus MTa receives the IP address of the multipoint conference control apparatus MCU and the conference ID from the presence server (process 104), so that the mobile communication terminal apparatus MTa connects to the multipoint conference control apparatus MCU to start remote conference communications (process 105).

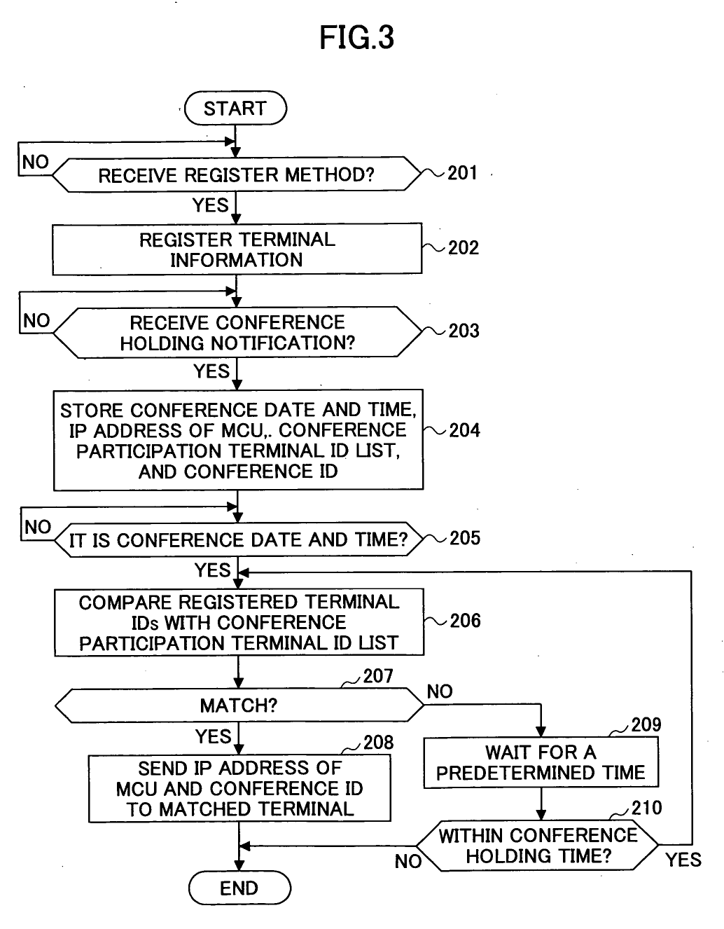

FIG. 3 shows an example of the presence server apparatus SPa.

When the presence server apparatus SPa receives a REGISTER method from a terminal (Yes in determination 201), the presence server apparatus SPa registers the terminal information included in the received REGISTER method (process 202).

In addition, when the presence server apparatus SPa receives the conference holding notification (process 203), the presence server apparatus SPa stores the conference holding date and time, the IP address of the multipoint conference control apparatus MCU, the conference participation terminal ID list including IDs of terminals that participate in the conference, and the conference ID (process 204).

Then, at the conference holding date and time (Yes in determination 205), the presence server apparatus SPa compares registered terminal IDs with the conference participation terminal ID list (process 206) so as to check whether there is a match (determination 207). When the result of the determination 207 is YES, the presence server apparatus SPa sends the IP address of the multipoint conference control apparatus MCU and the conference ID to a terminal having the terminal ID matched with one in the list (process 208).

When the result of the determination 207 is NO, the presence server apparatus SPa waits for a predetermined time (process 209), and checks whether current time is within the conference holding date and time period (determination 210). When the result of the determination 210 becomes YES, the process returns back to the process 206 and processes after that are performed repeatedly.

When the result of the determination 210 is NO, the operation ends. That is, during time other than the specified conference holding time period, the presence server apparatus SPa does not perform comparison of the registered terminal IDs with the conference participation terminal list, and does not perform the notification.

Also in the network NTb, similar operation as the operation in the network NTa is performed, so that the mobile communication terminal apparatus MTb connects to the multipoint conference control apparatus MCU to establish each channel of voice, video and data, and to send/receive each media data with other conference participating terminals via the multipoint conference control apparatus MCU so as to perform remote conference communication.

In the above-mentioned embodiment, the presence server apparatus (SPa, SPb) operates so as to urge the registered terminal to participate in the conference only during the conference holding time period. But, the presence server apparatus may send, to the mobile communication terminal apparatus (MTa, MTb), conference holding date and time in addition to the IP address of the multipoint conference control apparatus MCU and the conference ID before the conference holding time and date comes, so that the mobile communication terminal apparatus (MTa, MTb) may connect to the multipoint conference control apparatus MCU to perform remote conference communication when the conference holding date and time comes.

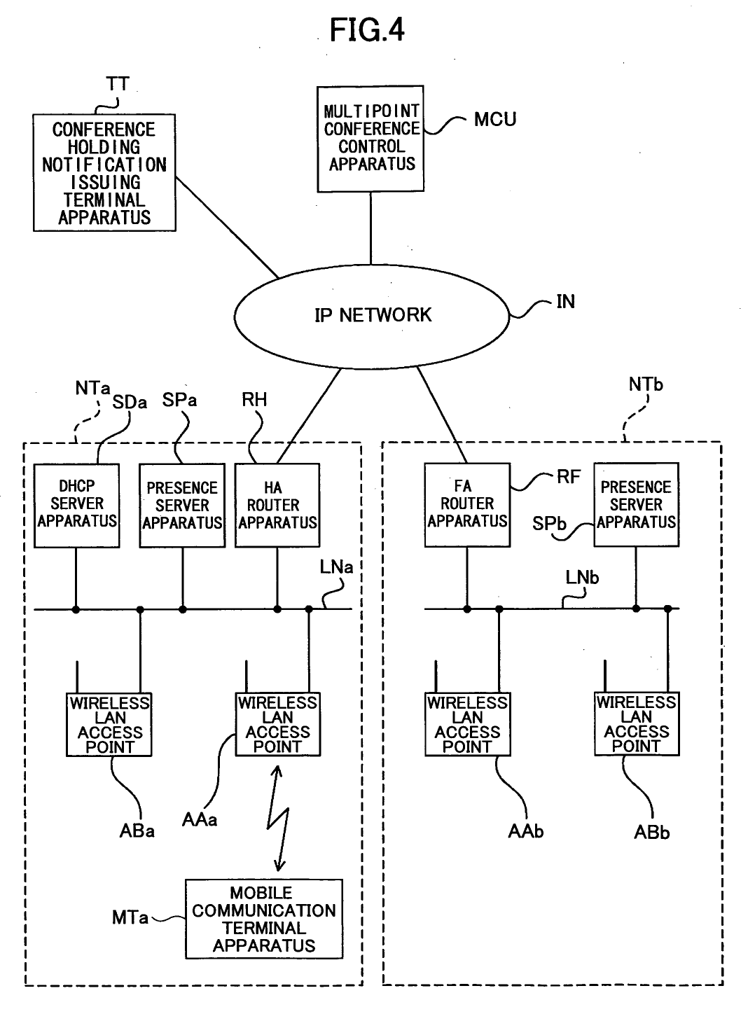

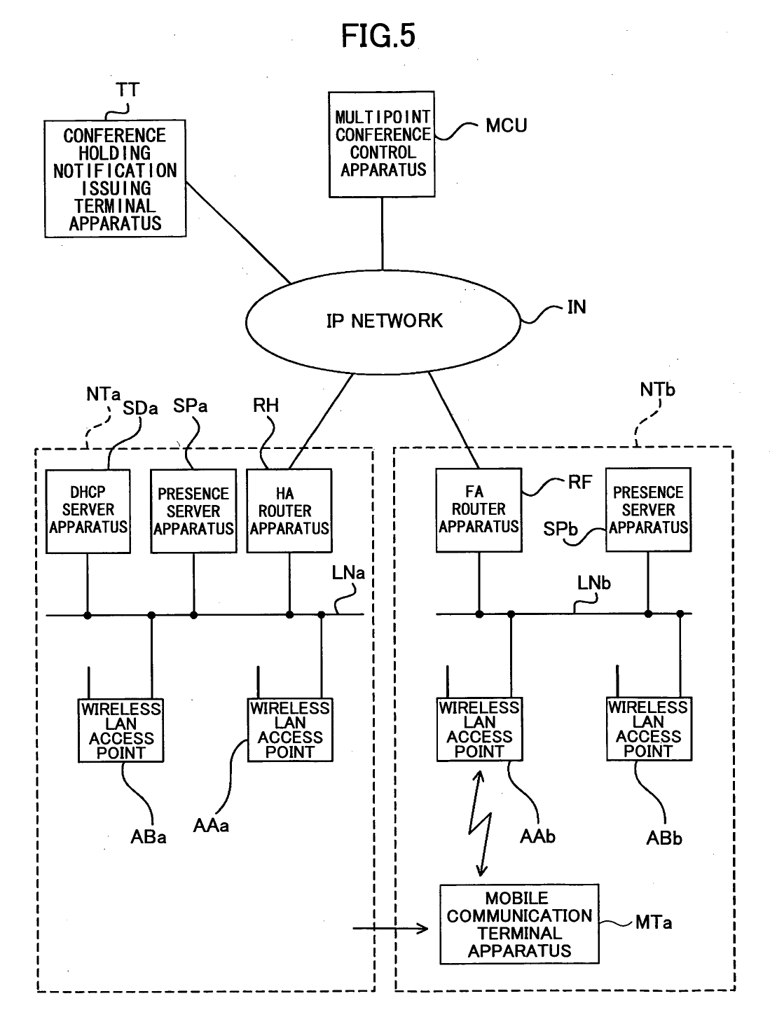

FIGS. 4 and 5 show a network system of another embodiment of the present invention. In this embodiment, a case is described in which the mobile communication terminal apparatus MTa participating in the remote conference moves to a different network (link) under an environment of mobile IP of IPv4(Internet Protocol version 4).

FIG. 4 shows a state in which the mobile communication terminal apparatus MTa participating in the remote conference connects to the network NTa, and FIG. 5 shows a state in which the mobile communication terminal apparatus MTa moves from the network NTa to the network NTb and connects to the network NTb. In FIGS. 4 and 5, the same references are assigned to parts corresponding to those of FIG. 1, and detailed description is not given.

In this embodiment, compared with the embodiment shown in FIG. 1, a home agent (HA) router apparatus RH is added to the network NTa, a foreign agent (FA) router apparatus RF is added to the network NTb.

The home agent router apparatus RH holds a correspondence between the home address of the mobile terminal and an address (care of address) used in the move destination network, so as to transfer a packet to the home address of the mobile terminal to the foreign agent router apparatus RF residing in the move destination network. In addition, the foreign agent router apparatus RF transfers a packet, to the mobile terminal, received from the home agent router apparatus RH, and the foreign agent router apparatus RF periodically broadcasts the care of address.

In the above configuration, when the mobile communication terminal apparatus MTa connects to the network NTa, the mobile communication terminal apparatus MTa registers the terminal information in the presence server apparatus SPa. Then, the mobile communication terminal apparatus MTa connects to the multipoint conference control apparatus MCU specified from the presence server apparatus SPa to start the remote conference communication.

After that, when the mobile communication terminal apparatus MTa moves from a connection area of the NTa to an area for connecting to the wireless LAN access point AAb of the network NTb as the user moves, the mobile communication terminal apparatus MTa connects to the wireless LAN access point AAb wirelessly, so as to receive the care of address from the foreign agent router apparatus RF.

Then, the mobile communication terminal apparatus MTa sends a position registration message including the IP address (home address) and the care of address to the foreign agent router apparatus RF, wherein the IP address (home address) is obtained when mobile communication terminal apparatus MTa connects to the network NTa.

The foreign agent router apparatus RF transfers this message to the home agent apparatus RH, and the home agent router apparatus RH stores the home address and the care of address of the mobile communication terminal apparatus MTa associating them with each other.

As to the above-mentioned notification of the care of address from the foreign agent router apparatus RF and transmission of the position registration message including the home address and the care of address, the specification is described in RFC2002. Operation of the notification of the care of address and the transmission of the position registration message follows the specification.

On the other hand, the multipoint conference control apparatus MCU does not ascertain that the mobile communication terminal apparatus MTa moves between networks and continues communications for the home address of the mobile communication terminal apparatus MTa.

After that, the home agent router apparatus RH encapsulates the packet sent from the multipoint conference control apparatus MCU to the home address of the mobile communication terminal apparatus MTa into an IP packet having the care of address of the mobile communication terminal apparatus MTa as a destination according to the RFC2003. Then, the IP packet is transferred to the foreign agent router apparatus RF.

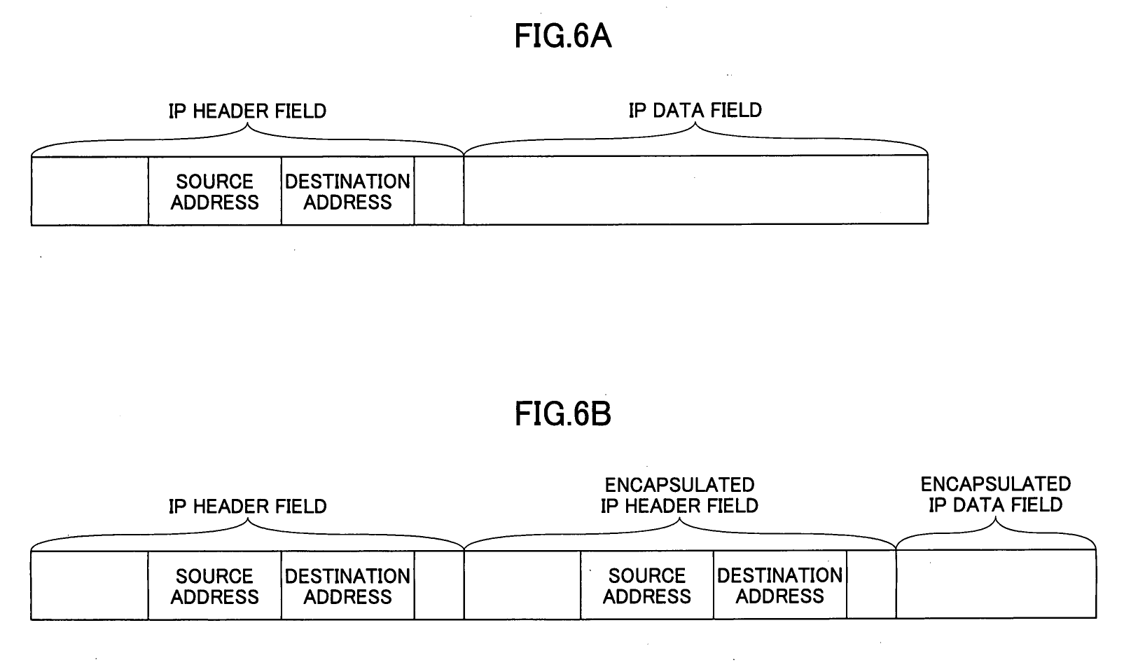

FIG. 6A shows the IP packet before the encapsulation, and FIG. 6B shows the IP packet after the encapsulation. When the foreign agent router apparatus RF receives the encapsulated packet, the foreign agent router apparatus RF deletes the IP header field that is an encapsulation header including the IP address of the home agent router apparatus RH and the care of address of the mobile communication terminal apparatus MTa, and sends the packet to the home address of the mobile communication terminal apparatus MTa.

As to transmission to the multipoint conference control apparatus MCU, the mobile communication terminal apparatus MTa continues to use the IP address of the multipoint conference control apparatus MCU specified by the presence server apparatus SPa as it is, so that the transmission packet is transferred to the multipoint conference control apparatus MCU without going through the home agent router apparatus RH.

As mentioned above, even though the mobile communication terminal apparatus MTa moves between the networks, the mobile communication terminal apparatus MTa can perform remote conference communication with other conference participation terminal via the multipoint conference control apparatus MCU without registering the terminal information to the presence server in the move destination network.

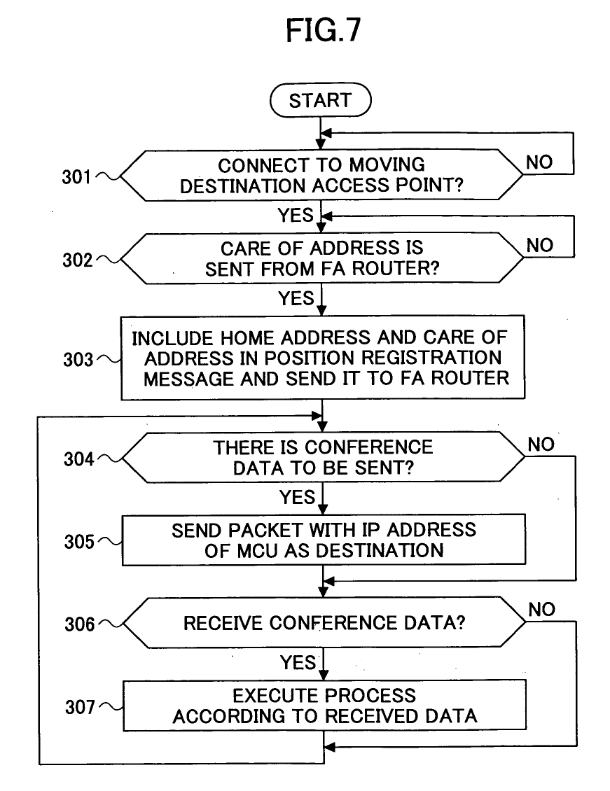

FIG. 7 shows an example of an operation flow when the mobile communication terminal apparatus MTa moves from the connection area of the network NTa to an area for connecting to the wireless LAN access point AAb of the network NTb.

First, the mobile communication terminal apparatus MTa checks that the mobile communication terminal apparatus MTa connects to the wireless LAN access point of the move destination (Yes in determination 301), the mobile communication terminal apparatus MTa waits until the care of address is received from the foreign agent router apparatus RF (No loop of determination 302).

When the care of address is received from the foreign agent router apparatus RF so that the result of determination 302 becomes YES, the mobile communication terminal apparatus MTa sends the position registration message including the home address and the care of address to the foreign agent router apparatus RF (process 303).

After that, when conference data to be sent occurs (Yes in determination 304), the mobile communication terminal apparatus MTa generates a packet, for transmitting the conference data, including the IP address of the multipoint conference control apparatus MCU as a destination address, and sends the packet (process 305). When the mobile communication terminal apparatus MTa receives conference data (Yes in determination 306), the mobile communication terminal apparatus MTa performs processes according to the received data (process 307).

The operation of processes 304-307 is executed repeatedly while the conference session continues.

By the way, in a case when displaying position information and a currently connecting network of each conference participation terminal on a screen shared by each conference participation terminal, the mobile communication terminal apparatus MTa registers terminal information to the presence server apparatus existing in a move destination network.

Then, a chair terminal periodically contacts each presence server apparatus SPa, SPb for the registration status of the conference participation terminal apparatuses, and displays correspondence information between the network in which the presence server apparatus SPa, SPb exists and the conference participation terminals on the shared screen. Detailed description in this case is not given.

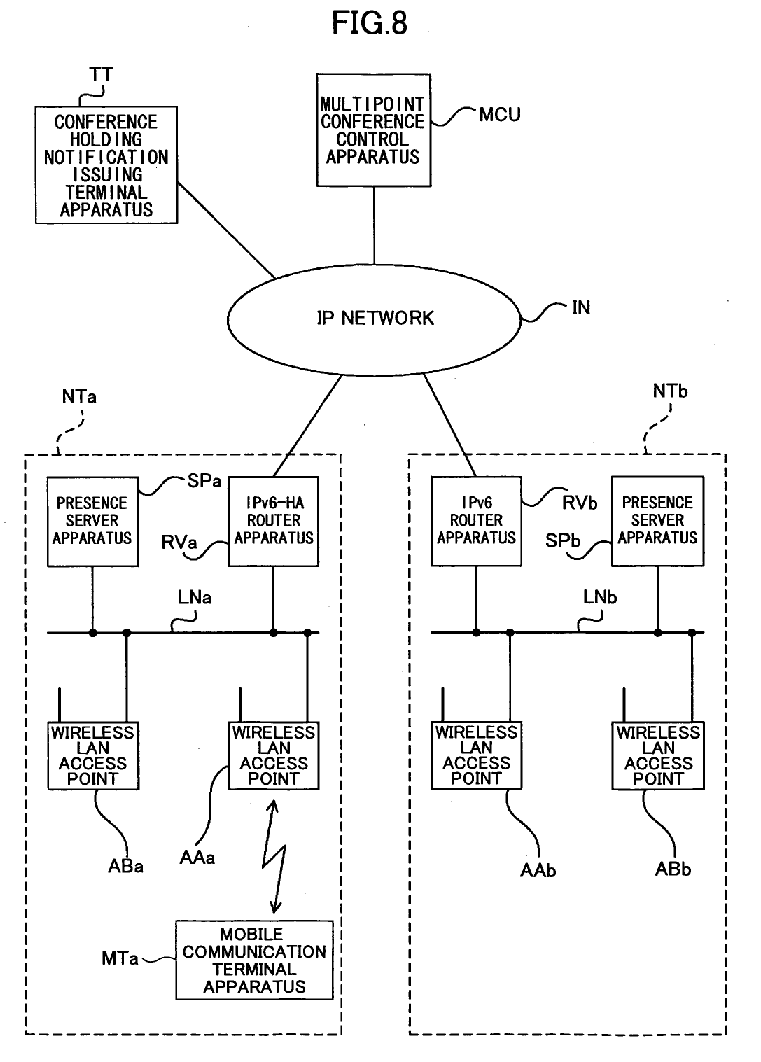

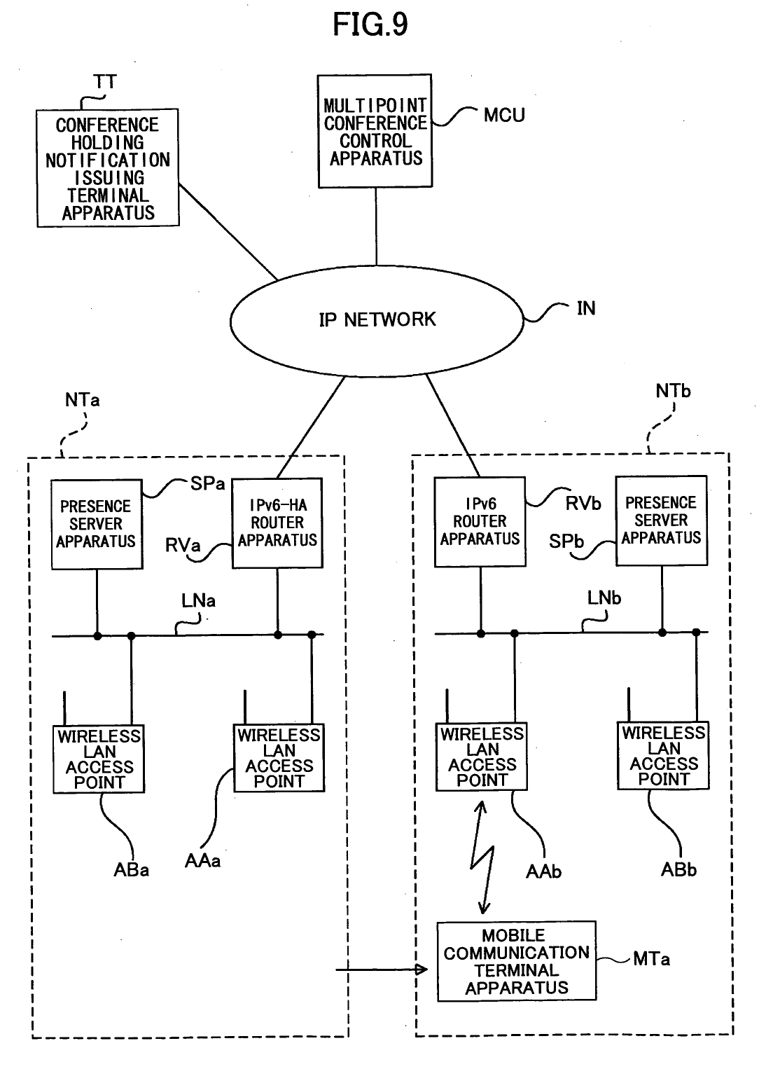

FIGS. 8 and 9 show a network system of still another embodiment of the present invention. In this embodiment, a case is described in which the mobile communication terminal apparatus MTa participating in the remote conference moves to a different network (link) under an environment of mobile IP of IPv6 (Internet Protocol version 6).

FIG. 8 shows a state in which the mobile communication terminal apparatus MTa participating in the remote conference connects to the network NTa, and FIG. 9 shows a state in which the mobile communication terminal apparatus MTa moves from the network NTa to the network NTb and connects to the network NTb. In FIGS. 8 and 9, the same references are assigned to parts corresponding to those of FIG. 1, and detailed description is not given.

In this embodiment, compared with the embodiment shown in FIG. 1, a IPv6 home agent (HA) router apparatus RVa is added to the network NTa, an IPv6 router apparatus RVb is added to the network NTb.

The IPv6 home agent router apparatus RVa holds a correspondence between the home address of the mobile terminal and an address (care of address) used in the move destination network, so as to transfer a packet to the home address of the mobile terminal directly to the mobile communication terminal apparatus MTa existing in the move destination network.

The IPv6 router apparatus RVb periodically broadcasts the network prefix (high 8 bytes of the IPv6 address) indicating a unique link number. Other apparatuses shown in FIGS. 8 and 9 all support IPv6.

In the above configuration, when the mobile communication terminal apparatus MTa connects to the network NTa, the mobile communication terminal apparatus MTa registers the terminal information in the presence server apparatus SPa. Then, the mobile communication terminal apparatus MTa connects to the multipoint conference control apparatus MCU specified from the presence server apparatus SPa to start the remote conference communication.

After that, when the mobile communication terminal apparatus MTa moves from a connection area of the NTa to an area for connecting to the wireless LAN access point AAb of the network NTb as the user moves, the mobile communication terminal apparatus MTa connects to the wireless LAN access point AAb wirelessly, so as to receive the network prefix from the IPv6 router apparatus RVb.

After receiving this notification, the mobile communication terminal apparatus MTa generates a care of address (global address) from the network prefix and the interface identifier by an automatic address generation function.

The interface identifier is generated by inserting FFFE (hexadecimal notation) bits into the middle (between 24th bit and 25th bit) of a MAC address, and by inverting 7th bit from the first bit.

Then, the mobile communication terminal apparatus MTa includes the IP address (home address) generated when connecting to the network NTa and the care of address into the position registration message, and sends the message to the IPv6 home agent router apparatus RVa using IPsec (IP security), in which the IP address is generated from the network prefix received from the IPv6 home agent router apparatus RVa and the interface identifier.

The IPv6 home agent router apparatus RVa authenticates the received home address of the mobile communication terminal apparatus MTa. When the validity is verified, the IPv6 home agent router apparatus RVa stores the home address of the mobile communication terminal apparatus MTa and the care of address by associating them with each other.

On the other hand, the multipoint point conference control apparatus MCU does not ascertain that the mobile communication terminal apparatus MTa moves between networks and continues communications for the home address of the mobile communication terminal apparatus MTa.

After that, the IPv6 home agent router apparatus RVa encapsulates the packet sent from the multipoint conference control apparatus MCU to the home address of the mobile communication terminal apparatus MTa into an IP packet having the care of address of the mobile communication terminal apparatus MTa as a destination. Then, the IP packet is directly transferred to the mobile communication terminal apparatus MTa. The structures of the packet data before and after encapsulation are the same as those shown in FIGS. 6A and 6B.

When the mobile communication terminal apparatus MTa receives the encapsulated packet, the mobile communication terminal apparatus MTa deletes the IP header field that is an encapsulation header including the IP address of the IPv6 home agent router apparatus RVa and the care of address of the mobile communication terminal apparatus MTa, so as to extract the packet to the home address of the mobile communication terminal apparatus MTa and process the packet.

As to transmission to the multipoint conference control apparatus MCU, the mobile communication terminal apparatus MTa sends the packet to the IPv6 home agent router apparatus RVa using the reverse tunneling function, so that the IPv6 home agent router apparatus RVa transfers the packet to the multipoint conference control apparatus MCU.

In this case, after that, it is possible that the multipoint conference control apparatus MCU and the mobile communication terminal apparatus MTa directly communicate with each other without going through the IPv6 home agent router apparatus RVa by executing the mobile IPv6 route optimization function.

In the route optimization function of the mobile IPv6, the mobile communication terminal apparatus MTa sends the position registration message, to the multipoint conference control apparatus MCU, including the home address and the care of address, and the multipoint conference control apparatus MCU stores the addresses.

At this time, before the mobile communication terminal apparatus MTa sends the position registration message to the multipoint conference control apparatus MCU, a test procedure is performed for checking, by the multipoint conference control apparatus MCU, whether the mobile communication terminal apparatus MTa validly has the home address and the care of address.

In the test procedure, temporary keys for authenticating the mobile communication terminal apparatus MTa are exchanged between the mobile communication terminal apparatus MTa and the multipoint conference control apparatus MCU using both of a route passing through the IPv6 home agent router apparatus RVa and a route without passing through the IPv6 home agent router apparatus RVa (optimized route), and the validity of the home address and the care of address of the mobile communication terminal apparatus MTa is verified by the sameness of the keys passing through the routes.

As mentioned above, even though the mobile communication terminal apparatus MTa moves from the network NTa to the network NTb, the mobile communication terminal apparatus MTa can perform remote conference communication with the conference participation terminal via the multipoint conference control apparatus MCU without registering the terminal information to the presence server SPb that covers the network NTb that is the move destination.

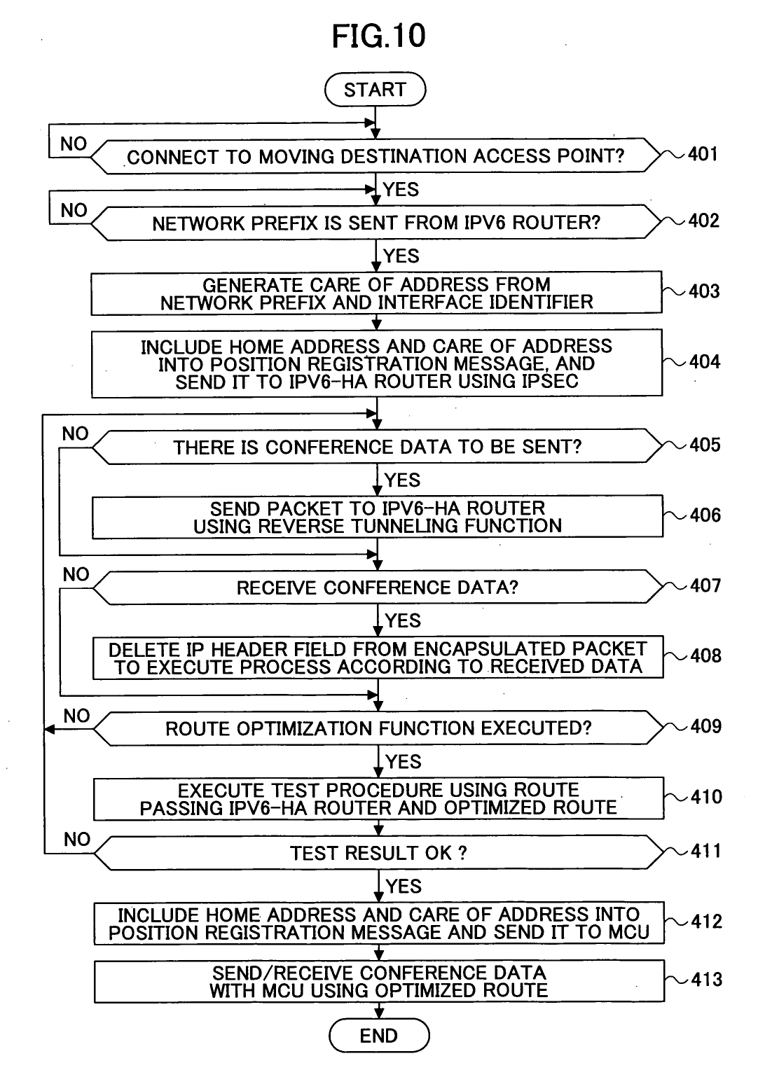

FIG. 10 shows an example of an operation flow when the mobile communication terminal apparatus MTa moves from the connection area of the network NTa to an area for connecting to the wireless LAN access point AAb of the network NTb.

After the mobile communication terminal apparatus MTa checks that the mobile communication terminal apparatus MTa is connected to the a wireless LAN access point of the move destination (Yes in determination 401), the mobile communication terminal apparatus MTa waits until the network prefix is sent from the IPv6 router apparatus RVb (No loop in determination 402).

When the network prefix is sent from the IPv6 router apparatus RVb so that the result of the determination 402 becomes YES, the mobile communication terminal apparatus MTa generates the care of address from the network prefix and the interface identifier (process 403), and the mobile communication terminal apparatus MTa sends the position registration message to the IPv6 home agent router apparatus RVa using IPsec in which the position registration message includes the home address and the care of address (process 404).

After that, when conference data to be transmitted occurs (Yes in the determination 405), the mobile communication terminal apparatus MTa sends the packet conveying the conference data to the IPv6 home agent router apparatus RVa using the reverse tunneling function (process 406). In addition, when receiving the conference data (Yes in determination 407), the mobile communication terminal apparatus MTa deletes the IP header field of the encapsulated packet, and performs processes according to the received data (process 408). The operation of the processes 405-408 are repeated until the route optimization function is executed (No loop of determination 409).

When the route optimization function is executed so that the result of the determination 409 becomes YES, the test procedure is performed using the route passing thorough the IPv6 home agent router apparatus RVa and the optimized route (process 410), so as to check whether the test result is OK (determination 411).

When the result of the determination 411 is No, the process returns to the process 405 to perform conference data communication in order to use the current route.

In addition, when the result of the determination 411 is YES, the mobile communication terminal apparatus MTa includes the home address and the care of address into the position registration message to send the message to the multipoint conference control apparatus MCU (process 412). After that, data communication between the mobile communication terminal apparatus MTa and the multipoint conference control apparatus MCU is performed using the optimized route (process 413).

The above-mentioned specification of the mobile IPv6 is described in the internet draft draft-ietf-mobileip-ipv6-24.txt.

By the way, in a case when displaying position information and a currently connecting network of each conference participation terminal on a screen shared by each conference participation terminal, the mobile communication terminal apparatus MTa registers terminal information to the presence server apparatus SPb existing in the move destination network.

Then, a chair terminal periodically contacts each presence server apparatus SPa, SPb for the registration status of the conference participation terminal apparatuses, and displays correspondence information between the network in which the presence server apparatus SPa, SPb exists and the conference participation terminal on the shared screen. Detailed description in this case is not given.

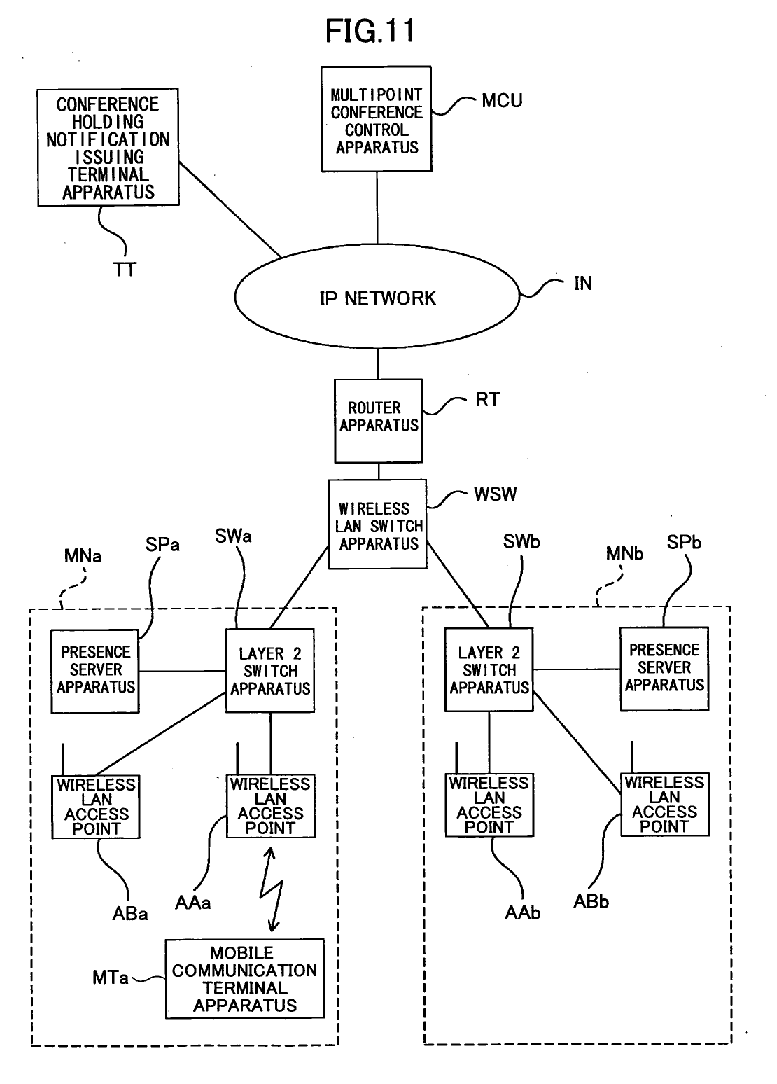

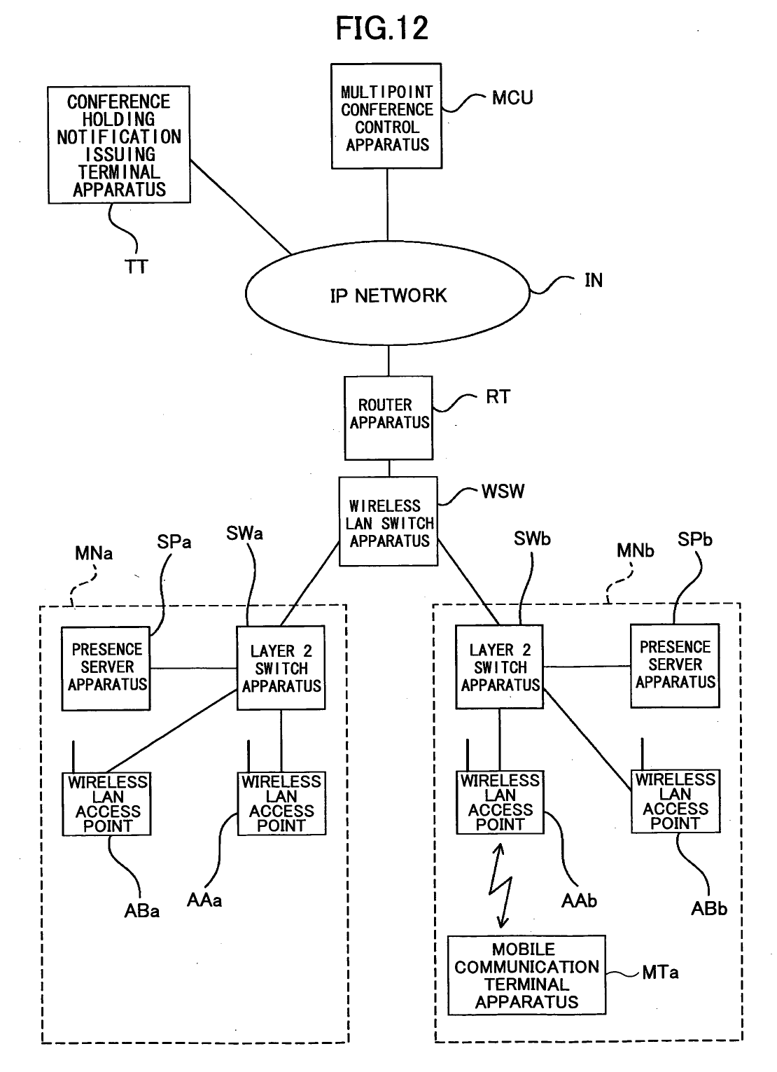

FIGS. 11 and 12 show a example of a network system of still another embodiment of the present invention. In this embodiment, a case is described in which the mobile communication terminal apparatus MTa participating in the remote conference moves to a different network (sub-network) so that using IP address is changed.

FIG. 11 shows a state in which the mobile communication terminal apparatus MTa participating in the remote conference connects to the network NTa, and FIG. 12 shows a state in which the mobile communication terminal apparatus MTa moves from the network NTa to the network NTb and connects to the network NTb. In FIGS. 11 and 12, the same references are assigned to parts corresponding to those of FIG. 1, and detailed description is not given.

The wireless LAN switch apparatus WSW manages wireless LAN access points AAa, ABa, AAb, and ABb, and the mobile communication terminal apparatus MTa in which the wireless LAN access points AAa, ABa, AAb, and ABb are connected to a plurality of sub-networks via the layer 2 switch apparatuses SWa and SWb, and the mobile communication terminal apparatus MTa is connected any one of the wireless LAN access points. The wireless LAN switch apparatus WSW performs processes for showing, for the communication partner terminal, that the IP address of the mobile terminal MTa is not changed even though the IP address is actually changed when the mobile communication terminal apparatus MTa communicating in the wireless LAN moves to a different sub-network (between MNa and MNb in this embodiment).

The wireless LAN switch apparatus WSW also includes a DHCP server function, and an authentication function using an authentication server such as a RADIUS(Remote Authentication Dial-In User Services) server, and the like.

In the above-mentioned configuration, when the mobile communication terminal apparatus MTa connects to the network MNa, the mobile communication terminal apparatus MTa sends a request for assigning an IP address to the wireless LAN switch WSW so as to obtain the IP address. For example, the IP address is 192.168.10.10.

Then, the mobile communication terminal apparatus MTa registers the terminal information in the presence server apparatus SPa, and connects to the multipoint conference control apparatus MCU specified by the presence server apparatus SPa to start remote conference.

After that, when the mobile communication terminal apparatus MTa moves from the connection area of the network MNa to an area for connecting to the wireless LAN access point AAb of the network MNb as the user moves, the mobile communication terminal apparatus MTa connects to the wireless LAN access point AAb by wireless.

At this time, since the sub-network of the network MNb is different from that of the network MNa, the mobile communication terminal apparatus MTa sends a request for assigning an IP address to the wireless LAN switch apparatus WSW to obtain an IP address again. For example, the IP address is 192.168.20.10.

The wireless LAN switch apparatus WSW also manages the MAC address as the terminal information of the mobile communication terminal apparatus MTa, so that the wireless LAN switch apparatus WSW can detect that the mobile communication terminal apparatus MTa moves from the neighborhood of the wireless LAN access point AAa of the network MNa to the neighborhood of the wireless LAN access point AAb of the network MNb.

The wireless LAN switch apparatus WSW receives a packet sent from the multipoint conference control apparatus MCU to the mobile communication terminal apparatus MTa, wherein the packet has a destination address: 192.168.10.10 that is the address when the mobile communication terminal apparatus MTa is connected to the network MNa. Then, the wireless LAN switch apparatus WSW replaces the destination address with an address: 192.168.20.10 that is one in the network MNb, and sends the packet to the mobile communication terminal apparatus MTa.

As mentioned above, even though the IP address is changed due to the movement of the mobile communication terminal apparatus MTa, the mobile communication terminal apparatus MTa can perform remote conference communication with other conference participation terminals via the multipoint conference control apparatus MCU without registering the terminal information in the presence server apparatus SPb.

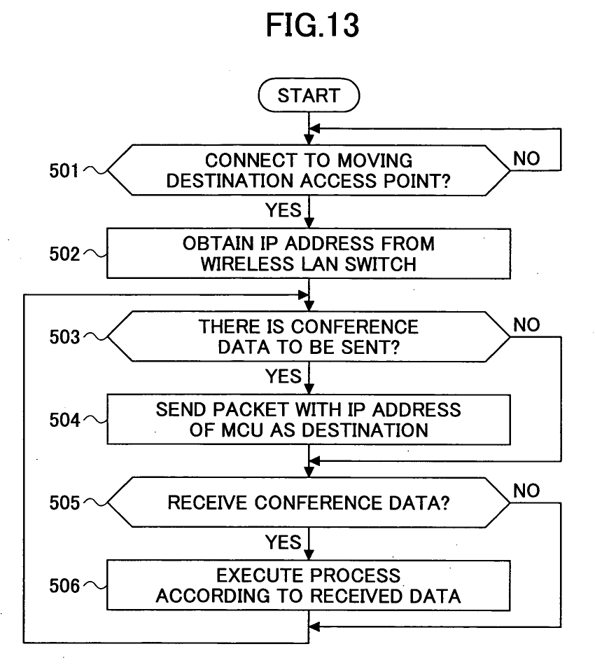

FIG. 13 shows an example of an operation flow when the mobile communication terminal apparatus MTa moves from the connection area of the network MNa to an area for connecting to the wireless LAN access point AAb of the network MNb.

When the mobile communication terminal apparatus MTa checks that it is connected to a move destination wireless LAN access point (Yes in determination 501), the mobile communication terminal apparatus MTa obtains the IP address from the wireless LAN switch apparatus WSW (process 502).

After that, when conference data to be transmitted occurs (YES in determination 503), the mobile communication terminal apparatus MTa generates a packet for transmitting the conference data with the IP address of the multipoint conference control apparatus MCU as a destination address, and sends the packet (process 504). When the mobile communication terminal apparatus MTa receives conference data (YES in determination 505), the mobile communication terminal apparatus MTa performs processes according to the received data (process 506).

The operation of the processes 503-506 is performed repeatedly while the conference session is continuing.

By the way, in a case when displaying position information and a currently connecting network of each conference participation terminal on a screen shared by each conference participation terminal, the mobile communication terminal apparatus MTa registers terminal information to the presence server apparatus SPb existing in a move destination network.

Then, a chair terminal periodically contacts each presence server apparatus SPa, SPb for the registration status of the conference participation terminal apparatuses, and displays correspondence information between the network in which the presence server apparatus SPa, SPb exists and the conference participating terminal on the shared screen. Detailed description in this case is not given.

The present invention is not limited to the specifically disclosed embodiments, and variations and modifications may be made without departing from the scope of the present invention.

Especially, the processes of the above-mentioned presence server apparatuses SPa, SPb can be executed by presence server software installed in a general-purpose computer.

The present application contains subject matter related to Japanese patent application No. 2005-170735, filed in the JPO on Jun. 10, 2005, the entire contents of which being incorporated herein by reference.

What is claimed is:

1. A remote conference system comprising:
at least one remote conference participation terminal apparatus configured to participate in a remote conference;
a presence server apparatus configured to store conference related information and registration information of the remote conference participation terminal apparatus, and
a multipoint conference control apparatus configured to connect to the remote conference participation terminal apparatus so as to control the remote conference,
wherein the presence server apparatus determines whether a conference participation permitted terminal included in the conference related information is registered as the remote conference participation terminal apparatus, and the presence server apparatus sends, to the remote conference participation terminal apparatus, connection information used for connecting to the multipoint conference control apparatus when the conference participation permitted terminal included in the conference related information is registered as the remote conference participation terminal apparatus, and
the remote conference participation terminal apparatus connects to the multipoint conference control apparatus to participate in the remote conference according to the connection information received from the presence server apparatus.

2. The remote conference system as claimed in claim 1, wherein the presence server apparatus determines whether the conference participation permitted terminal included in the conference related information is registered as the remote conference participation terminal apparatus only during conference holding time that is included in the conference related information, and the presence server apparatus sends, to the remote conference participation terminal apparatus, the connection information used for connecting to the multipoint conference control apparatus when the conference participation permitted terminal included in the conference related information is registered as the remote conference participation terminal apparatus.

3. The remote conference system as claimed in claim 1, wherein, after the conference participation terminal starts to perform the remote conference by connecting to the multipoint conference control apparatus, the conference participation terminal does not access the presence server apparatus until communication for the remote conference is disconnected.

4. The remote conference system as claimed in claim 3, wherein, in an mobile IP network environment, when the remote conference participation terminal moves to a link that is different from a link to which the remote conference participation terminal is previously connected, the remote conference participation terminal continues conference communication using a handover function.

5. The remote conference system as claimed in claim 3, wherein the remote conference participation terminal is connected to a wireless communication network containing a wireless LAN switch apparatus, and when the IP address of the remote conference participation terminal is changed due to movement of the remote conference participation terminal, the remote conference participation terminal continues conference communication using a handover function without accessing the presence server apparatus until the conference communication is disconnected.

6. A presence server apparatus in a remote conference system comprising: at least one remote conference participation terminal apparatus configured to participate in a remote conference; the presence server apparatus configured to store conference related information and registration information of the remote conference participation terminal apparatus; and a multipoint conference control apparatus configured to connect to the remote conference participation terminal apparatus so as to control the remote conference,
wherein the presence server apparatus determines whether a conference participation permitted terminal included in the conference related information is registered as the remote conference participation terminal apparatus, and the presence server apparatus sends, to the remote conference participation terminal apparatus, connection information used for connecting to the multipoint conference control apparatus when the conference participation permitted terminal included in the conference related information is registered as the remote conference participation terminal apparatus.

7. The presence server apparatus as claimed in claim 6, wherein the presence server apparatus determines whether the conference participation permitted terminal included in the conference related information is registered as the remote conference participation terminal apparatus only during conference holding time that is included in the conference related information, and the presence server apparatus sends, to the remote conference participation terminal apparatus, the connection information used for connecting to the multipoint conference control apparatus when the conference participation permitted terminal included in the conference related information is registered as the remote conference participation terminal apparatus.

8. A remote conference participation terminal apparatus in a remote conference system comprising: the remote conference participation terminal apparatus configured to participate in a remote conference; a presence server apparatus configured to store conference related information and registration information of the remote conference participation terminal apparatus; and a multipoint conference control apparatus configured to connect to the remote conference participation terminal apparatus so as to control the remote conference,
wherein the remote conference participation terminal apparatus connects to the multipoint conference control apparatus to participate in the remote conference according to connection information received from the presence server apparatus.

9. The remote conference participation terminal apparatus as claimed in claim 8, wherein, after the remote conference participation terminal starts to perform the remote conference by connecting to the multipoint conference control apparatus, the remote conference participation terminal does not access the presence server apparatus until communication for the remote conference is disconnected.

10. The remote conference participation terminal apparatus as claimed in claim 9, wherein, in an mobile IP network environment, when the remote conference participation terminal moves to a link that is different from a link to which the remote conference participation terminal is previously connected, the remote conference participation terminal continues conference communication using a handover function.

11. The remote conference participation terminal apparatus as claimed in claim 9, wherein the remote conference participation terminal is connected to a wireless communication network containing a wireless LAN switch apparatus, and when the IP address of the remote conference participation terminal is changed due to movement of the remote conference participation terminal, the remote conference participation terminal continues conference communication using a handover function without accessing the presence server apparatus until the conference communication is disconnected.
